(19) United States
(12) Patent Application Publication
(10) Pub. No.: US 2004/0155985 A1
(43) Pub. Date: Aug. 12, 2004

(54) Interface unit

(76) Inventor: Frank Dethier, Hasselt (DE)

Correspondence Address: Corporate Patent Counsel, Philips Electronics North America Corporation, P O Box 3001, Briarcliff Manor, NY, 10510, US

(21) Appl. No.: 10/479,363

(22) PCT Filed: May 28, 2002
(86) PCT No.: PCT/IB02/01890

(30) Foreign Application Priority Data
Jun. 5, 2001 (EP) 01202125.9

(51) Int. Cl. H04N 7/173; H04N 7/16; H04B 1/66; H04N 7/12; H04N 5/50

(52) U.S. Cl. 348/731; 725/133; 725/131; 725/139; 375/240.25

(57) ABSTRACT

A set-top-box (STB) for receiving cable TV (CATV) transmission and connecting to the Internet. The STB comprises a first tuner arranged to receive a signal transmitted on a channel via a physical medium e.g. a cable network; and at least a first decoder (e.g. a MPEG decoder and a MAC decoder) arranged to convert a signal supplied to the decoder into a first output signal. The STB is characterized by a second tuner providing a signal to a second decoder (e.g. a MPEG decoder) arranged to convert a signal received from the second tuner to a second output signal that can co-exist with the first output signal. Thereby either two digital TV channels can be received simultaneously or a TV channel can be received while IP data from the Internet is received.

This invention relates to an interface unit particularly a set-top-box with a first tuner arranged to receive a signal transmitted on a channel via a physical medium; and at least a first decoder arranged to convert a signal supplied from the tuner into a first output signal.

A set-top-box is an interface that allows a user to select a channel distributed via a broadband network. The set-top-box converts content on a selected channel to a format suitable for presenting the content. The broadband network connects content providers such as TV stations or Internet providers with an Internet gateway to subscribers connected to the network via the set-top-box. Typically, the broadband network is a cable network since this type of network provides the best bandwidth to price ratio.

Compared to receiving ordinary cable TV the set-top-boxes have become very popular since they provide users with more advanced options for watching television including digital cable TV (D-CATV), Video-on-demand (VOD), etc. and services such as Internet connections.

More widespread and more intense use of the Internet has increased the demand for fast Internet connections. Since broadband cable networks can provide higher transmission speed than ordinary telephone lines the option of obtaining Internet connection via a set-top-box has increased the demand for set-top-boxes.

The German patent application DE-19811826 discloses an embodiment of a system for providing an Internet service to a PC via a set-top-box at the same time as digital cable TV (D-CATV) and video on demand (VOD). The set-top-box is connected to a network providing the D-CATV and VOD services. The set-top-box comprises a network interface unit which comprises a receiver for receiving data from the network, and a decoder for decoding MPEG data, resulting in audio and video data to be displayed on a TV. The D-CATV provider comprises an Internet gateway, and the set-top-box comprises means for analysing virtual channel cells and for forwarding such cells via a serial line internet protocol (SLIP) to a PC which is connected to the set-top-box.

However, the prior art involves the problem that the bandwidth of one channel only is used for receiving contents to multiple bandwidth consumers. Thus, available bandwidth must be shared by different consumers e.g. a TV set receiving TV signals and a computer receiving IP data. Alternatively, only one channel can be received.

These problems are solved according to the invention when the device mentioned in the opening paragraph is characterized by a second tuner providing a signal to a second decoder arranged to convert a signal received from the second tuner to a second output signal that can co-exist with the first output signal.

Consequently, when individual channels are transmitted via the physical medium, multiple of the individual channels can be received at the same time without sharing the same bandwidth. Typically, the physical medium is a cable network distributing both television signals and data in accordance with the Internet Protocol. Thus, both a television channel and a data channel can be received at the same time with full bandwidth. This may increase the value of the interface since in a modern family Internet access has become a source of information/recreation/entertainment on the lines of watching TV. Alternatively, two television channels can be received e.g. to provide so-called picture-in-picture options.

In a preferred embodiment the interface unit is arranged to be connected to a network that transmits broadcast transmissions and addressed data. Typically broadcast transmissions comprises TV transmissions whereas addressed data comprises Video-on-demand and IP data. Thereby both IP data and television/video signals can be received.

When at least one of the tuners is arranged to selectively receive either broadcast transmissions or addressed data by selecting a channel, the interface is flexible. Since channels received by the first and second tuner are carried on the same physical media the interface can be made compact.

The first decoder can be arranged to decode a digital representation of a signal received by the first tuner and provide a decoded signal in a format supported by an audio or video player or a television. Thereby simple interfacing to existing products is obtained.

The second decoder can be arranged to decode a digital representation of a signal received by the first tuner and provide a decoded signal according to a protocol supported by a computer arranged for data network communication. Thereby the interface can provide high-speed data downloaded to a computer while a TV signal is provided to a television.

When the interface unit comprises a third decoder arranged to convert a signal supplied from the first tuner into an output signal the first tuner can be utilized in a more flexible way i.e. to receive respective channels with different types of information.

In an expedient embodiment the interface unit has switch means arranged to provide the first output signal as a signal decoded by either the first or third decoder. This allows for selecting an output signal from a decoder that is capable of decoding signals transmitted on a selected channel.

In a preferred embodiment the third decoder is arranged to decode a digital representation of a signal received by the second tuner and provide a decoded signal in a format recognized by an audio or video player or a television.

The third decoder can be arranged to decode a digital representation of a signal received by the second tuner and provide a decoded signal according to a protocol supported by a computer arranged for data network communication.

The protocol supported by a computer can be the Internet Protocol.

The invention will be explained more fully below in connection with a preferred embodiment and with reference to the drawing, in which:

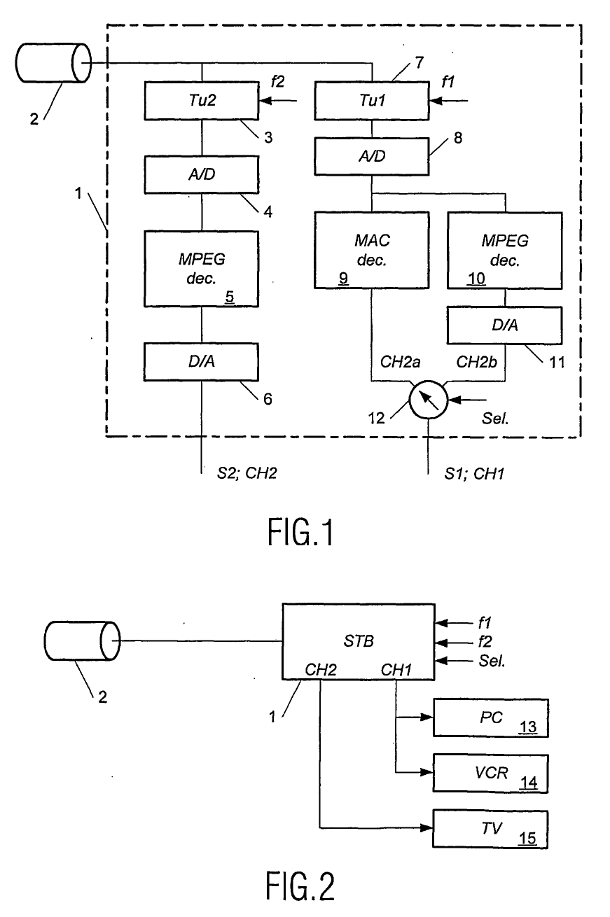

FIG. 1 shows a set-top-box according to the invention; and

FIG. 2 shows a block diagram for connecting peripherals to the set-top-box.

FIG. 1 shows a set-top-box according to the invention. The set-top-box 1 is arranged to be connected to a cable network 2 distributing channels with Digital cable TV (D-CATV), Video-on-demand (VOD), MAC (Media Access Control) encoded IP (Internet Protocol) data, etc. The channels are e.g. provided by television/radio stations and Internet gateway providers.

A first tuner (Tu1) 7 and a second tuner (Tu2) 3 are connected to receive signals from a common physical medium in the form of the cable network 2 and to select a channel at frequencies f1 and f2, respectively. Selected channels at f1 and f2 are converted from analogue representations to digital representations by means of A/D converters 4 and 8, respectively.

Digital signals from the A/D converter 8 are supplied to a Media Access Control (MAC) decoder 9 and/or an MPEG decoder 10. In a preferred embodiment the digital signals are supplied to a respective one of the decoders based on the type of signals received from the A/D converter 8. Thus if a MAC-IP data type is identified the data are routed to the MAC decoder. Alternatively, if a MPEG data type is identified the data are routed to the MPEG decoder.

The MAC decoder 9 provides a signal CH1 a carrying IP data to a selector 12. The MPEG decoder 10 provides a signal CH1b carrying audio/video information to the selector 12 via digital-to-analogue converter (D/A). Thereby a video signal in a digital—particularly a MPEG—format is converted to an ordinary television or audio signal. The selector can be of any switch means type but is preferably an integrated circuit type. The selector 12 can select to output either the signal CH1a or Ch1b in response to a control signal (Sel.). The control signal can be selected automatically in response to the type of signals received from the A/D converter 8, manually by a user, or in response to a selected channel given by it's frequency f2. The output from the selector 12 is provided as a signal S1 at output CH1.

In an alternative preferred embodiment the signals CH1a and Ch1b are provided as separate outputs e.g. in a combined IEEE1394 interface.

Digital signals from the A/D converter 4 are supplied to a further MPEG decoder 5 for converting a digital MPEG signal via D/A converter 6 to a TV or audio signal. The resulting TV or audio signal is provided as a signal S1 at output CH2.

FIG. 2 shows a block diagram for connecting peripherals to the set-top-box. The set-top-box 1 is connected to a network 2 as described above for providing at least two outputs CH1 and CH2 providing audio/video signals at output CH1, and IP data or audio/video signals at output CH2. A television 15 is connected to output CH1. A computer (PC) 13 and a video recorder (VCR) 14 are connected to output CH2 that provides either audio/video signals or IP data.

Channels carrying information to be provided at output CH1 and CH2 can be selected by specifying f1 and f2, respectively, as the frequencies at which the channels are located.

It should be noted that the tuners 3 and 7 can be selected to be of the same type since the physical medium is common for the two tuners.

Moreover, it should be noted that MAC (Media Access Control) encoded data are addressed data with an address identifying a computer's physical address. MAC is a device dependent sublayer of a Data-Link-Layer (DLC) of a telecommunications protocol. An Internet provider supplying IP data to individual computers connected via the cable network and a set-top-box will have a table linking IP addresses to a MAC address to transmit data from the Internet to the individual computers on the cable network.

1. An interface unit (1) particularly a set-top-box with a first tuner (7) arranged to receive a signal transmitted on a channel via a physical medium;
at least a first decoder (9; 10) arranged to convert a signal supplied from the first tuner (7) into at least a first output signal (S2);
characterized by
a second tuner (3) providing a signal to a second decoder (5) arranged to convert a signal received from the second tuner (3) to a second output signal (S1) that can co-exist with the first output signal (S2).

2. An interface unit according to claim 1 characterized in that the interface unit (1) is arranged to be connected to a network (2) that transmits broadcast transmissions and addressed data.

3. An interface unit according to claim 1 characterized in that at least one of the tuners (3;7) is arranged to selectively receive either broadcast transmissions or addressed data by selecting a channel.

4. An interface unit according to claim 1 characterized in that the first decoder (9) is arranged to decode a digital representation of a signal received by the first tuner (7) and provide a decoded signal in a format supported by an audio or video player or a television.

5. An interface unit according to claim 1 characterized in that the second decoder (10) is arranged to decode a digital representation of a signal received by the first tuner (7) and provide a decoded signal according to a protocol supported by a computer arranged for data network communication.

6. An interface unit according to claim 1 characterized in that the interface unit (1) comprises a third decoder (10) arranged to convert a signal supplied from the first tuner (7) into an output signal (S2).

7. An interface unit according to claim 1 characterized in that the interface unit (1) has switch means (12) arranged to provide the first output signal (S2) as a signal decoded by either the first or third decoder (9;10).

8. An interface unit according to claim 6 characterized in that the third decoder (5) is arranged to decode a digital representation of a signal received by the second tuner (3) and provide a decoded signal in a format recognized by an audio or video player (14) or a television (15).

9. An interface unit according to claim 1 characterized in that the third decoder (5) is arranged to decode a digital representation of a signal received by the second tuner (3) and provide a decoded signal according to a protocol supported by a computer (13) arranged for data network communication.

10. An interface unit according to claim 9 characterized in that the protocol supported by a computer (13) is the Internet Protocol.
